(19) United States
(12) Patent Application Publication
(10) Pub. No.: US 2009/0040945 A1
(43) Pub. Date: Feb. 12, 2009

(54) SYSTEMS AND METHODS FOR UTILIZING GLOBAL TRAFFIC FLOW PARAMETERS FOR PACKET-BASED NETWORKS

(75) Inventors: Ariton E. XHAFA, Plano, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/174,331

(22) Filed: Jul. 16, 2008

Related U.S. Application Data
(60) Provisional application No. 60/955,106, filed on Aug. 10, 2007.

(51) Int. Cl. H04L 12/28

(52) U.S. Cl. 370/254

(57) ABSTRACT

Embodiments achieve simpler solutions to coexistence problems for wireless network subsystems in a single device. Some embodiments describe systems and methods for determining change in at least one network technology traffic flow, performing mapping functions between network technology-specific parameters of the changed traffic flow and global traffic flow parameters, and prioritizing the at least one changed network technology traffic flow based on the mapped global traffic flow parameters. Further embodiments alternatively describe a mapper for performing mapping between at least one network technology-specific parameter of a network technology subsystem traffic flow and at least one global traffic flow parameter.

### CROSS-REFERENCE TO RELATED APPLICATION

The present application claims priority to U.S. provisional patent application Ser. No. 60/955,106, filed Aug. 10, 2007, and entitled “Global Traffic Flow Parameters for Packet-Based Networks”, hereby incorporated in its entirety herein by reference.

### BACKGROUND

Next-generation mobile devices will be able to access a variety of network technologies including, for example, worldwide interoperability for microwave access (WiMAX) networks, wireless local area network (WLAN) networks, long term evolution (LTE) mobile telephony networks, personal area networks (PANs), wireless universal serial bus (USB) networks or BLUETOOTH (BT) networks, etc.

The various applications have different transmission timing requirements in order to provide a needed quality of service (QoS). Quality of service refers to mechanisms for controlling resource reservation rather than the achieved service quality. QoS is the ability to provide different priority to different applications, users, or data flows, or to guarantee a certain level of performance to a data flow, e.g., guarantee a required bit rate, delay, jitter, packet dropping probably, bit error rate, etc. Quality of service guarantees are important, for example, if the network capacity is insufficient or limited, especially for real-time streaming multimedia applications such as voice over IP, online games and IP-TV, since these delay sensitive applications often require fixed bit rate.

The IEEE802.11 specification provides a quality of service control protocol that enables a service differentiation to be provided for packets. For example, voice and e-mail traffic require different quality of service levels to provide acceptable service quality. In particular, voice packets need to be delivered within strict delay bounds whereas e-mail packets are more delay tolerant.

While increased access to these technologies will benefit users and operators alike, interference among different technologies, particularly onboard a single device, introduces difficulties during concurrent operation of these technologies. For example, and as illustrated in FIG. 1, WLAN (in 2.4-2.5 GHz) and WiMAX (2.3-2.4 GHz and 2.5-2.7 GHz) technologies operate at relatively close frequency bands with respect to each other—so close, in fact, that the out-of-band emission by either technology may saturate the receiver of the other technology resulting in potential blocking. Therefore, the interference between these two technologies operating in the same device creates challenges on the coexistence of the corresponding two wireless interfaces of that device.

As a result, various solutions are needed to enable the competition for resources among the technologies onboard a single device to be less apparent and less inconvenient to users.

### BRIEF DESCRIPTION OF THE DRAWINGS

For a detailed description of exemplary embodiments of the invention, reference will be made to the accompanying drawings in which:

FIG. 1 illustrates different network technologies and their operating bands;

FIG. 2 illustrates an example wireless local area network (WLAN) with an access point and a plurality of wireless devices/stations, according to embodiments;

FIG. 3 illustrates an exemplary access point and/or wireless device, according to embodiments;

FIG. 4 illustrates an exemplary device, according to embodiments; and

FIG. 5 illustrates an exemplary method of utilizing global traffic flow parameters, according to embodiments.

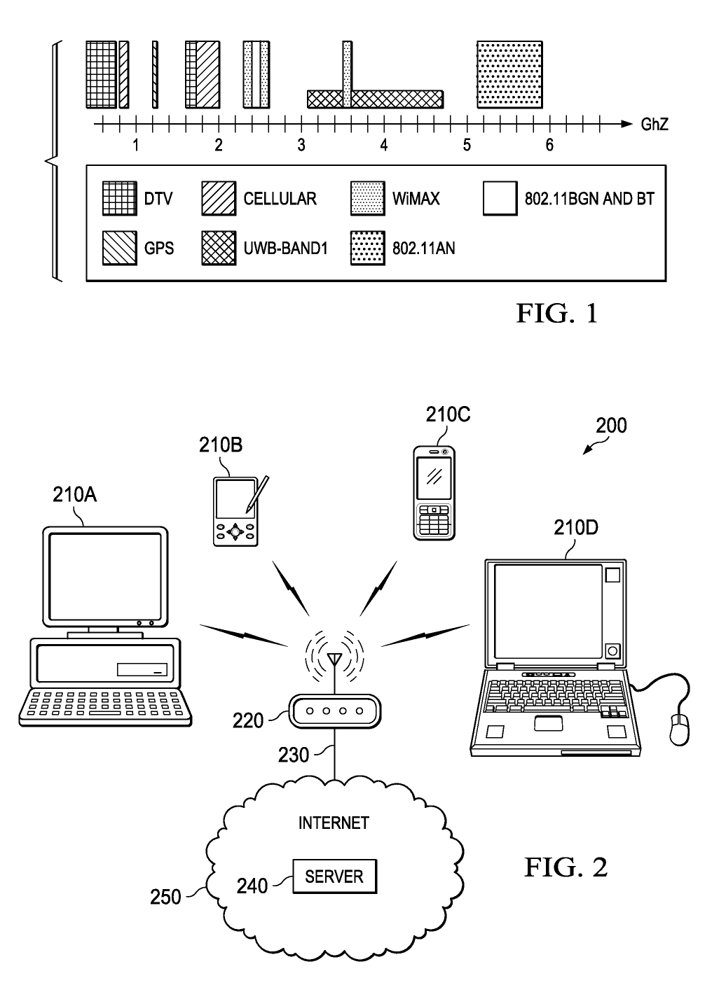

### NOTATION AND NOMENCLATURE

Certain terms are used throughout the following description and claims to refer to particular system components. As one skilled in the art will appreciate, computer companies may refer to a component by different names. This document doe not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In supporting coexistent network technologies onboard the same device, resource management is a concern. With completely separate traffic flows for each network technology represented on a device—as well as the separate parameters unique to each of those traffic flows—it is necessary for a device controller to store all of the parameters for each of the network traffic flows and keep track how each are to be monitored, reported and acted upon. This becomes a further burden—from both development as well as device resource management standpoints—for each new network technology added to a device.

In light of the foregoing, embodiments are directed in general, to communication systems and, more specifically, the use of global quality of service (QoS) parameters for traffic flows in devices with co-existent network technologies, one of which is wireless. Embodiments provide global parameters, which enable device scalability, strong QoS support and more robust performance of wireless network subsystems in a single device.

Moreover, mapping the specific active flow parameters of a network technology to global parameters, reduces memory consumption, and improves flexibility/performance of the scheduler, thereby resulting in a more efficient scheduler among the different networks vying for the device's resources.

FIG. 2 illustrates an example wireless local area network (WLAN) 200 with a plurality of wireless devices/stations—referred to individually herein as device, station, STA or device/station—and an access point (AP), according to embodiments. It should be appreciated that the network of FIG. 2 is meant to be illustrative and not meant to be exhaustive; for example, it should be appreciated that more, different or fewer communication systems, devices and/or paths may be used to implement embodiments. To provide wireless data and/or communication services (e.g., telephone services, Internet services, data services, messaging services, instant messaging services, electronic mail (email) services, chat services, video services, audio services, gaming services, etc.), the exemplary WLAN 200 comprises AP 220 and any of a variety of fixed-location and/or mobile wireless devices or stations (STAs), four of which are respectively designated in FIG. 2 with reference numerals 210A, 210B, 210C and 210D. Exemplary devices 210 include any variety of personal computer (PC) 210A with wireless communication capabilities, a personal digital assistant (PDA) 210B, an MP3 player, a wireless telephone 210C (e.g., a cellular phone, a Voice over Internet Protocol (VoIP) telephonic functionality, a smart phone, etc.), and a laptop computer 210D with wireless communication capabilities, etc. At least one of AP 220 and STAs 210A-D are preferably implemented in accordance with at least one wired and/or wireless communication standard (e.g., from the IEEE 802.11 family of standards). Further, at least one device 210 comprises a plurality of co-existing wireless network technology subsystems onboard the at least one device 210.

In the example of FIG. 2, to enable the plurality of devices/STAs 210A-D to communicate with devices and/or servers located outside WLAN 200, AP 220 is communicatively coupled via any of a variety of communication paths 230 to, for example, any of a variety of servers 240 associated with public and/or private network(s) such as the Internet 250. Server 240 may be used to provide, receive and/or deliver, for example, any variety of data, video, audio, telephone, gaming, Internet, messaging, electronic mail, etc. service. Additionally or alternatively, WLAN 200 may be communicatively coupled to any of a variety of public, private and/or enterprise communication network(s), computer(s), workstation(s) and/or server(s) to provide any of a variety of voice service(s), data service(s) and/or communication service(s).

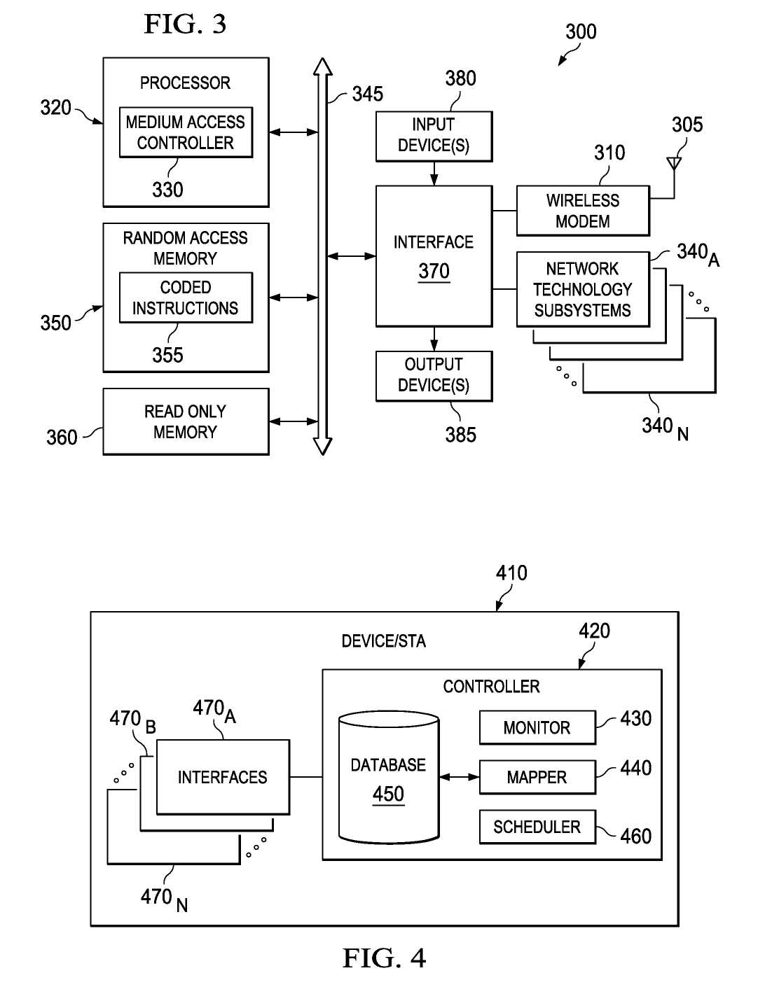

The systems and methods described herein may be implemented on any general-purpose computer with sufficient processing power, memory resources, and network throughput capability to handle the necessary workload placed upon it. FIG. 3 illustrates an exemplary, general-purpose computer system suitable for implementing at least one embodiment of a system to respond to signals as disclosed herein. Illustrated exemplary device 300 which may be an access point and/or wireless device, according to embodiments. It should be expressly understood that any device on, for example, WLAN 200 or other embodiments, may at times be an access point and at other times be a station. It should also be understood that in some embodiments, there may be at least one dedicated access point, with any number of devices acting as stations.

Exemplary device 300 comprises at least one of any of a variety of radio frequency (RF) antennas 305 and any of a variety of wireless modems 310 that support wireless signals, wireless protocols and/or wireless communications (e.g., according to IEEE 802.11n). RF antenna 305 and wireless modem 310 are able to receive, demodulate and decode WLAN signals transmitted to and/or within a wireless network. Likewise, wireless modem 310 and RF antenna 305 are able to encode, modulate and transmit wireless signals from device 300 to and/or within a wireless network. Thus, RF antenna 305 and wireless modem 310 collectively implement the “physical layer” (PHY) for device 300. It should be appreciated that device 300 is communicatively coupled to at least one other device and/or network (e.g., a local area network (LAN), the Internet 250, etc.). It should further be understood that illustrated antenna 305 represents one or more antennas, while the illustrated wireless modem 310 represents one or more wireless modems.

The exemplary device 300 further comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an advanced reduced instruction set computing (RISC) machine (ARM) processor, etc. Processor 320 executes coded instructions 355 which may be present in a main memory of the processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by DRAM, SDRAM, and/or any other type of RAM device; ROM 360 may be implemented by flash memory and/or any other type of memory device.

Processor 320 implements MAC 330 using one or more of any of a variety of software, firmware, processing thread(s) and/or subroutine(s). MAC 330 provides medium access controller (MAC) functionality and further implements, executes and/or carries out functionality to facilitate, direct and/or cooperate in utilizing global traffic or service flow parameters. MAC 330 is implemented by executing one or more of a variety of software, firmware, processing thread(s) and/or subroutine(s) with the example processor 320; further, MAC 330 may be, additionally or alternatively, implemented by hardware, software, firmware or a combination thereof, including using an application specific integrated circuit (ASIC), a programmable logic device (PLD), a field programmable logic device (FPLD), discrete logic, etc.

Device 300 also preferably comprises at least one input device 380 (e.g., keyboard, touchpad, buttons, keypad, switches, dials, mouse, track-ball, voice recognizer, card reader, paper tape reader, etc.) and at least one output device 385 (e.g., liquid crystal display (LCD), printer, video monitor, touch screen display, a light-emitting diode (LED), etc.)—each of which are communicatively connected to interface 370.

Interface 370, additionally or alternatively, communicatively couples wireless modem 310 with processor 320 and/or MAC 330. Interface 370 enables interface to, for example and not by way of limitation, Ethernet cards, universal serial bus (USB), token ring cards, fiber distributed data interface (FDDI) cards, network interface cards, wireless local area network (WLAN) cards, etc. to enable device 300 to communicate with other devices and/or communicate via Internet 250 or at least one intranet. With such a network connection, it is contemplated that processor(s) 320 would be able to receive information from at least one type of network technology, and/or output information to at least one type of network technology in the course of performing the herein-described processes. It should be appreciated that interface 370 implements at least one of a variety of interfaces, such as an external memory interface, serial port, communication internal to device 300, general purpose input/output, etc.

Device 300 further comprises at least two dissimilar network technology subsystems 340; as a result, device 300 is said to have co-existing network technology. “Dissimilar” is used in this context to mean that at least one of the subsystems 340 is from a different network technology than another one of the subsystems 340. It should be understood that some embodiments of subsystems 340 may have their own dedicated wireless modem and antenna, while other embodiments may share either or both of a wireless modem and antenna. Embodiments of device 300 comprise at least two wireless network technology subsystems 340. FIG. 3 illustrates network technology subsystems 340_{A}-340_{N}, where N=the number network technology subsystems in device 300. Examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, etc. Processor 320 interacts with network technology subsystems 340 via corresponding interfaces 470_{A}-470_{N} (see FIG. 4) implemented by interface 370. It should be appreciated that, for the ease of illustration, only two or three such network technologies may be discussed in connection with any particular embodiment, that more or fewer such technologies may be onboard a device, and that the present teachings apply equally thereto.

As illustrated in FIG. 4, an exemplary device 410 comprises a controller 420 and interfaces 470_{A}-470^{N}, where N=the number of onboard network technologies corresponding to each of the respective dedicated interfaces. Controller 420, in turn, comprises monitor 430, mapper 440, database 450 and scheduler 460. Mapper 440 performs various mapping functions. Embodiments of device 410 consist of wireless—and, in some cases, wired—links, where each link has a capacity constraint. Because at least some of the links are wireless, some communications may interfere with each other. For example, it may not be possible for two links to be active at the same time because the transmission of one interferes with the transmission of the other. Preferably time division multiplexing is used where interfering links operate at different times, but embodiments of scheduler 460 preferably understands the priority and parameters of each network technology. Having uniform/unified parameters among the onboard network technologies improves the flexibility and performance of the device scheduler, while condensing the coding for mapping (e.g., reduces memory use).

Controller 420 schedules for how long each active network traffic flow may keep priority on device 410's resources. There are a variety of scheduling options, one of which may be fair allocation. Generally, the device alternates among the various active traffic flows depending upon each service/traffic flow's priority as determined by scheduler 460. Each network preferably takes sequential turns in using device 410's resources to send packets to—or otherwise communicate with—networks outside of device 410. It should also be appreciated that, in many embodiments, controller 420 also comprises additional functionality such as security inputs (often from a user), managing power saving features for the interfaces, etc.

Controller 420 calls monitor 430 to monitor global traffic flow; in some embodiments, monitor 430 only monitor's the existence of active traffic flows onboard device 410, while in other embodiments, monitor 430 also monitors what network technology (e.g., WLAN, BT, WiMax, etc.) and what type of transmission (e-mail, streaming video, VoIP, etc.) are affected. It should be appreciated that embodiments involve traffic flows regardless of type of traffic or whether the traffic is unicast, broadcast, multicast, etc.

Additionally, in at least some embodiments, controller 420 employs monitor 430, to track changes in the active traffic flows. If monitor 430 determines that there has been a change in at least one of the active traffic flows, it also identifies the change. As one example, and not by way of limitation, a WLAN MAC sends a trigger to controller 420 indicating that it wants to add some traffic, i.e., initiate a traffic flow. If, for example, monitor 430 ascertains that there has been a newly activated traffic flow, then controller 420 calls mapper 440 to map the unique traffic flow parameters of the new network technology traffic flow to the global traffic flow parameters, and outputs the mapped global traffic parameters to database 450, which global traffic parameters function as input to scheduler 460. If, instead, monitor 430 ascertains that there has been a decreased number of active traffic flows—in other words, one of the previously active traffic flows is no longer active—controller 420 calls mapper 440 to unmap the global traffic flow parameters corresponding to the now inactive traffic flow, and output the unique traffic flow parameters of the corresponding network technology to database 450. Once again, such changes are accepted as input by scheduler 460 to affect scheduling and prioritization of any remaining active traffic flows. If, alternatively, monitor 430 determines that there has been a performance change in at least one of the active traffic flows, controller 420 calls mapper 440 to remap the global traffic flow parameters corresponding to the specific aspects that have changed. As one example, the packet error rate may have dropped—or increased—meaning that the scheduler 460 will have to work with the appropriate interface 470 to adjust the level of error coding, or transmission rate, etc. due to the changed performance of the affected traffic flow.

Thus, scheduler 460 prioritizes the service calls (requests) based on the information gathered by monitor 430, which information is mapped to global traffic flows parameters by mapper 440. Mapper 440 provides an interface from actual traffic flow parameters specific to each type of network to global traffic flow parameters. Such ability frees scheduler 460 from having to separately and/or duplicatively maintain and understand all unique traffic flow parameter formats for each network technology onboard the device; instead, scheduler 460 can more dynamically focus on scheduling among the requests for service. As a result, by using the global traffic parameters instead of having to look-up and manage separate sets of traffic flows parameters for each network technology onboard a device, the system becomes more scalable and the scheduler is more flexible.

Examples of global traffic flows parameters are described in Table 1. Although the parameters listed in Table 1 are described in the context of WiMAX and WLAN subsystems, it should be clearly understood that the approach is the same for other wireless networks (as well as wireline networks). Moreover, it should be readily appreciated that more or fewer global traffic flows parameters may be utilized by embodiments.

TABLE 1
Global traffic flows parameters.

| Traffic Parameters | Description | Usage |
|---|---|---|
| TF_TYPE | Traffic flow type | UGS, rtVR, ertVR, nrtVR, |
| | | BE |
| TF_DIRECTION | Traffic flow UL/DL | DL = 0, UL = 1, Peer-2-Peer = 3 |
| | indicator | |
| MEAN_SDU_SIZE | Traffic flow average | Can be used to calculate |
| | SDU_SIZE? | average periodicity of the |
| | | traffic flow. |
| MAX_SDU_SIZE | Traffic flow maximum | This can be used to |
| | MSDU size | estimate minimum |
| | | periodicity value to be |
| | | sustained. |
| MIN_RSV_RATE | Minimum reserved rate | Bits per second when |
| | for service flow for QoS | averaged over time |
| | requirements | |
| MAX_SUSTAIN_RATE | Maximum sustained peak | Guide actual service flow |
| | data rate for traffic flow | allocation. |
| MEAN_RATE | Average data rate (bps?) | Estimate average period |
| | | interval for service flow. |
| MAX_LATENCY | Maximum latency | Can be used to estimate |
| | between MSDU transmit | the time “off” for a |
| | to receive | particular flow. |
| MAX_PER | Maximum PER for the | Can be used to estimate |
| | traffic flow to maintain its | the number of times that |
| | QoS | transmission may be |
| | | deferred due to higher |
| | | priority tasks. |
| INTER_ARRIVAL_TIME | Maximum time period | Used to estimate |
| | within which the data | maximum “off” time for |
| | belongs to the TF will not | the corresponding TF. |
| | be transmitted | |
| PERIODICITY | Period time interval for | Can be used to estimate |
| | the flow. | the ON-OFF time for the |
| | | traffic flows. It can be |
| | | calculated from the data |
| | | rate and the SDU size. |
| START_TIME | Start time for the traffic | Can be used to estimate |
| | flow | when the scheduler |
| | | should start considering |
| | | the traffic flow. |

Some of the listed traffic parameters, such as PERIODICITY, can be derived from other traffic parameters. For example, based on the MEAN_RATE and MEAN_SDU_SIZE, periodicity of the service flows can be estimated as:

PERIODICITY=Interval(MEAN_SDU_SIZE/MEAN_RATE)

Once the traffic flow parameters have been collected and mapped, scheduler 460 of controller 420 ranks the active traffic flows based on the traffic type, TF_TYPE. For example, VoIP in WLAN and VoIP in WiMAX are preferably both ranked the highest—the controller preferably takes care of these flows before it accommodates/supports other traffic flows. The services are preferably arranged in a set of Quality of Service (QoS) classes to which priorities are assigned: unsolicited grant service (UGS), extended real-time variable rate (ERT-VR) real-time variable rate (RT-VR), non-real time variable rate (NRT-VR), best efforts (BE), etc. Resource scheduling is performed by sharing the radio resources available among the QoS classes as a function of the priorities, whereby the QoS classes having a lower priority (RT-VR) may utilize the amount of resources left unused by the classes having a higher priority (UGS, ERT-VR).

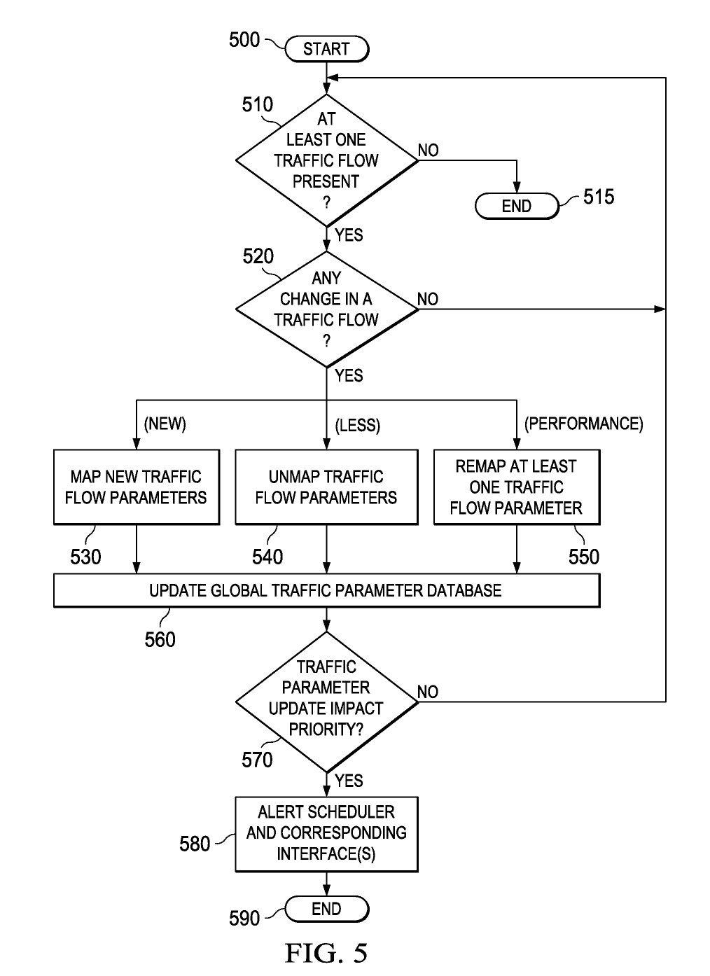

As illustrated in FIG. 5, an exemplary process for utilizing global traffic parameters starts (500) with a determination of whether there is at least one active traffic flow present on the device (block 510). In some embodiments, a determination is made at block 510 as to whether there is at least one wireless active traffic flow present on the device; in other embodiments, it is preferred such determination is made as to whether there is at least one traffic flow from at least two wireless network technology subsystems (block 510). If the condition of block 510 is not met, then the process ends (515). If, however, there is at least one active traffic flow, the controller determines whether there has been any change in a traffic flow. If there has been no change in an active traffic flow, then the process returns to determine whether there is at least one active traffic flow present (block 510). If there has been a change, the controller ascertains the nature of the change: a new (additional) active traffic flow, a cessation of a previously active traffic flow, or a change in the performance of at least one of the active traffic flows.

If there is a new or additional active traffic flow, the mapper is called to map the new traffic flow parameters to the global traffic flow parameters (block 530). If, instead, there has been a cessation of a previously active traffic flow, the mapper is again called to unmap the now-unneeded traffic flow parameters (block 540). If, the controller has determined that a change in the performance of at least one of the active traffic flows over a period of time has occurred, then the mapper is called to remap at least one of the traffic flow parameters to accurately reflect the current traffic flow (block 550). One example of traffic flow performance parameters that might change includes, but is not limited to, a steady or dropping packet error rate (PER). Changes with this parameter can effect how the interfaces 470 handle the packets for the corresponding network technology and have a corresponding effect on the respective active traffic flow.

Regardless of what change(s) has/have been monitored by controller 420, at least some embodiments update the global traffic parameter database 450 and provide these update(s) to the respective affected interface(s) 470. Once the parameter database has been updated, controller 420 determines whether the update impacts the priority of any of the active traffic flows (block 570). For example, if there has only been e-mail being wirelessly sent, and a new active traffic flow resulting from VoIP occurs, then the VoIP traffic flow will take priority over the e-mail. Alternatively, and not by way of limitation, if there was one VoIP traffic flow across WiMax technology network and a new active VoIP traffic flow across WLAN technology network, the WiMax technology may have to share the priority as the device sequentially switches between the two. There are numerous other variations.

If controller 420 determines that the update did not impact priority, e.g., the existing active traffic flow was a VoIP and the new active traffic flow is WLAN e-mail, then controller 420 returns to monitoring the traffic flows (block 510). If, however, controller 420 determines that the update does impact priority, controller 420 alerts scheduler 460 and corresponding interface(s) 470 (block 590). It should be appreciated that although FIG. 5 illustrates that the process ends (590) at this point and does not start again until triggered, in some embodiments, there may alternatively be a loop in the process immediately following block 580's notification of the scheduler and interfaces whereby the controller returns to block 510 to continue to monitor for any active traffic flow(s).

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A communication device, comprising:
a plurality of network technology subsystems; and
a mapper for performing mapping between at least one network technology-specific parameter of a network technology subsystem traffic flow and at least one global traffic flow parameter.

2. The communication device of claim 1, wherein the mapper further performs mapping of at least one network technology-specific parameter of a newly active network technology subsystem traffic flow to at least one global traffic flow parameter.

3. The communication device of claim 1, wherein the mapper further performs unmapping of at least one global traffic flow parameter corresponding to a newly inactive traffic flow to at least one network technology-specific parameter of a network technology subsystem traffic flow.

4. The communication device of claim 1, wherein the mapper further performs remapping at least one global traffic flow parameter of a network technology subsystem traffic flow resulting from a change in performance of the corresponding traffic flow.

5. The communication device of claim 1, further comprising a monitor able to monitor for change in at least one network technology subsystem traffic flow.

6. The communication device of claim 1, further comprises a controller able to update a global traffic parameter database.

7. The communication device of claim 1, wherein at least one of the plurality of network technology subsystems is wireless.

8. The communication device of claim 1, further comprises a scheduler for prioritizing the network technology traffic flow based on the mapped at least one global traffic flow parameter.

9. A method for communications, comprising:
determining change in at least one network technology traffic flow, the at least one network technology traffic flow resulting from at least one of a plurality of network technology subsystems in a single device;
performing mapping functions between network technology-specific parameters of the changed traffic flow and global traffic flow parameters; and
prioritizing the at least one changed network technology traffic flow based on the mapped global traffic flow parameters.

10. The method of claim 9, wherein performing mapping functions further comprises performing mapping of at least one network technology-specific parameter of a newly active network technology subsystem traffic flow to at least one global traffic flow parameter.

11. The method of claim 9, wherein performing mapping functions further comprises performing unmapping of at least one global traffic flow parameter corresponding to a newly inactive traffic flow to at least one network technology-specific parameter of a network technology subsystem traffic flow.

12. The method of claim 9, wherein performing mapping functions further comprises performing remapping at least one global traffic flow parameter of a network technology subsystem traffic flow resulting from a change in performance of the corresponding traffic flow.

13. The method of claim 9, further comprising monitoring for change in any network technology traffic flow in a single device.

14. The method of claim 9, further comprising updating a global traffic parameter database with the results of performing mapping.

15. The method of claim 9, wherein the determining further comprises determining change in at least one wireless network technology traffic flow.

16. A communications network, comprising:
at least one technology network; and
a device having at least two network technology subsystems onboard, the device further comprising:
a controller able to cause mapping between at least one network technology-specific parameter of a network technology subsystem traffic flow and at least one global traffic flow parameter, the controller further able to cause prioritizing of the network technology subsystem traffic flow based on the mapped global at least one global traffic flow parameter;
at least one interface through which the technology network subsystems interact with the at least one technology network.

17. The communications network of claim 16, wherein at least one technology network subsystem is wireless.

18. The communications network of claim 16, wherein the controller is further able to cause monitoring of at least one network technology subsystem traffic flow to detect change in the at least one traffic flow.

19. The communications network of claim 16, wherein the controller causes the mapping to map at least one network technology-specific parameter of a newly active network technology subsystem traffic flow to at least one global traffic flow parameter.

20. The communications network of claim 16, wherein the controller causes the mapping to unmap at least one global traffic flow parameter corresponding to a newly inactive traffic flow to at least one network technology-specific parameter of a network technology subsystem traffic flow.

21. The communications network of claim 16, wherein the controller causes the mapping to remap at least one global traffic flow parameter of a network technology subsystem traffic flow resulting from a change in performance of the corresponding traffic flow.

22. The communications network of claim 16, wherein the controller further causes updating of a global traffic flow parameter database.
